(19) United States
(12) Patent Application Publication
(10) Pub. No.: US 2022/0382976 A1
(43) Pub. Date: Dec. 1, 2022

(54) METHOD AND APPARATUS FOR EMBEDDING NEURAL NETWORK ARCHITECTURE

(71) Applicant: SAMSUNG SDS CO., LTD., Seoul (KR)

(72) Inventors: Jae-Sun SHIN, Seoul (KR); Suk-Hoon JUNG, Seoul (KR); Da-Seul BAE, Seoul (KR); Young-Jun KIM, Seoul (KR); Sung-Yoon KIM, Seoul (KR)

(21) Appl. No.: 17/751,926

(22) Filed: May 24, 2022

(30) Foreign Application Priority Data
May 25, 2021 (KR) 10-2021-0067283

(51) Int. Cl. G06F 40/279; G06N 3/04; G06N 3/08

(52) U.S. Cl. CPC G06F 40/279; G06N 3/04; G06N 3/08

(57) ABSTRACT

A neural network architecture embedding method according to an embodiment is performed by a computing device including one or more processors and a memory storing one or more programs executed by the one or more processors. The method generates a word data set for each of a plurality of layers of a neural network architecture on basis of one or more features of each of the plurality of layers, generates a graph regarding the neural network architecture on basis of the word data set and connection relationship between the plurality of layers, and generates a neural network architecture embedding vector for the neural network architecture by inputting the graph regarding the neural network architecture to a pre-trained network-vector transformation model.

### CROSS REFERENCE TO RELATED APPLICATION

This application claims the benefit under 35 USC § 119 of Korean Patent Application No. 10-2021-0067283, filed on May 25, 2021, the entire disclosure of which is incorporated herein by reference for all purposes.

### BACKGROUND

### 1. Field

Embodiments of the present disclosure relate to a neural network architecture embedding method and a learning method therefor.

### 2. Description of Related Art

A neural network architecture embedding technology has been used in neural architecture search (NAS), a type of automated machine learning (AutoML), which automatically generates, changes, and optimizes a deep learning neural network architecture of the related art.

In such NAS technology, a process of searching a neural network formed as a combination of a plurality of layers and the connection relationship between the layers may be categorized as a combination optimization issue. However, related-art NAS technology fundamentally has a vast search space, and thus some features of the neural network in the defined search space may be embedded and applied to a neural network having a limited architecture. An embedding space generated in this manner is also limited.

Recently, with increases in the consumption of artificial intelligence (AI) application services, various and complicated neural network architectures are used. In order to numerically analyze various and complicated neural network architectures, the need for a generalization technique able to embed a neural network architecture with numerical vectors has come to prominence.

The information disclosed in the Background section is only provided for a better understanding of the background and should not be taken as an acknowledgment or any form of suggestion that this information forms prior art that would already be known to a person having ordinary skill in the art.

### SUMMARY

Embodiments of the present disclosure provide a neural network architecture embedding technology for embedding a neural network architecture with numerical vectors.

According to an aspect, provided is a neural network architecture embedding method performed by a computing device including one or more processors and a memory storing one or more programs executed by the one or more processors, the method including: generating a word data set for each of a plurality of layers of a neural network architecture on basis of one or more features of each of the plurality of layers; generating a graph regarding the neural network architecture on basis of the word data set and connection relationship between the plurality of layers; and generating a neural network architecture embedding vector for the neural network architecture by inputting the graph regarding the neural network architecture to a pre-trained network-vector transformation model.

The one or more features may include a type of an operation and one or more parameters of the operation.

The graph may include a node corresponding to the word data set for each of the plurality of layers and a mainline corresponding to the connection relationship between the plurality of layers.

The operation of generating the neural network architecture embedding vector may include: generating a layer embedding vector by inputting the graph to a pre-trained layer-vector transformation model; generating a position embedding vector for the connection relationship between the plurality of layers by inputting the graph to a relative position encoder; and generating the neural network architecture embedding vector for the neural network architecture by inputting the layer embedding vector and the position embedding vector to the pre-trained network-vector transformation model.

The layer-vector transformation model may include a character convolutional neural network architecture configured to learn correlation between words of the word data set from combinations characters constituting each word.

The network-vector transformation model may include a relative position encoder transforming a dimension of the connection relationship between the character convolutional neural network and the plurality of layers.

According to another aspect, provided is a neural network architecture embedding method performed by a computing device including one or more processors and a memory storing one or more programs executed by the one or more processors, the method including: generating a word data set for each of a plurality of neural network layers on basis of one or more features of each of the plurality of neural network layers; training a layer-vector learning model to generate a layer embedding vector corresponding to each of the plurality of neural network layers using the word data set for each of the plurality of neural network layers; performing one or more perturbations to generate a plurality of perturbed neural network architectures for a reference neural network architecture; generating a word data set for each of a plurality of perturbed layers of the plurality of perturbed neural network architectures on basis of one or more features of each of the plurality of perturbed layers; generating a graph regarding each of the plurality of perturbed neural network architectures on basis of the word data set and connection relationship between the plurality of layers; and training a network-vector learning model to generate a perturbed neural network architecture embedding vector corresponding to each of the plurality of perturbed neural network architectures using the word data set for each of the plurality of perturbed layers of the plurality of perturbed neural network architectures and connection relationship between the plurality of perturbed layers.

The one or more perturbations may include at least one of mutation for at least one layer of the plurality of neural network layers and crossover of two or more of the plurality of layers.

The layer-vector learning model may be trained using: a layer embedding vector generated by a layer-vector transformation encoder on basis of the word data set for each of the plurality of perturbed neural network layers; and a reconstruction word data set for the layer embedding vector generated by a layer-vector transformation decoder on basis of the layer embedding vector.

The network-vector model may be trained using: a layer embedding vector generated by a network-vector transformation encoder on basis of the word data set for each of the plurality of neural network layers; and a reconstruction word data set for the layer embedding vector generated by a network-vector transformation decoder on basis of the layer embedding vector.

According to another aspect, provided is a neural network architecture embedding device including: a layer-word transformer generating a word data set for each of a plurality of layers of a neural network architecture on basis of one or more features of each of the plurality of layers; a graph generator generating a graph regarding the neural network architecture on basis of the word data set and connection relationship between the plurality of layers; and an embedding vector generator generating a neural network architecture embedding vector for the neural network architecture by inputting the graph regarding the neural network architecture to a pre-trained network-vector transformation model.

The one or more features may include a type of an operation and one or more parameters of the operation.

The graph may include a node corresponding to the word data set for each of the plurality of layers and a mainline corresponding to the connection relationship between the plurality of layers.

The embedding vector generator may generate a layer embedding vector by inputting the graph to a pre-trained layer-vector transformation model; generates a position embedding vector for the connection relationship between the plurality of layers by inputting the graph to a relative position encoder and generate the neural network architecture embedding vector for the neural network architecture by inputting the layer embedding vector and the position embedding vector to the pre-trained network-vector transformation model.

The layer-vector transformation model may include a character convolutional neural network architecture configured to learn correlation between words of the word data set from combinations of characters constituting each word.

The network-vector transformation model may include a relative position encoder transforming a dimension of the connection relationship between the character convolutional neural network and the plurality of layers.

According to another aspect, provided is a neural network architecture embedding device including: a layer-word transformer generating a word data set for each of a plurality of neural network layers on basis of one or more features of each of the plurality of neural network layers; a layer-vector model learning part training a layer-vector learning model to generate a layer embedding vector corresponding to each of the plurality of neural network layers using the word data set for each of the plurality of neural network layers; a neural network architecture transformer performing one or more perturbations to generate a plurality of perturbed neural network architectures for a reference neural network architecture; a graph generator generating a word data set for each of a plurality of perturbed layers of the plurality of perturbed neural network architectures on basis of one or more features of each of the plurality of perturbed layers and generating a graph regarding each of the plurality of perturbed neural network architectures on basis of the word data set and connection relationship between the plurality of layers; and a network-vector model learning part training a network-vector learning model to generate a perturbed neural network architecture embedding vector corresponding to each of the plurality of perturbed neural network architectures using the word data set for each of the plurality of perturbed layers of the plurality of perturbed neural network architectures and connection relationship between the plurality of perturbed layers.

The one or more perturbations may include at least one of mutation for at least one layer of the plurality of neural network layers and crossover of two or more of the plurality of layers.

The layer-vector learning model may be trained using: a layer embedding vector generated by a layer-vector transformation encoder on basis of the word data set for each of the plurality of perturbed neural network layers; and a reconstruction word data set for the layer embedding vector generated by a layer-vector transformation decoder on basis of the layer embedding vector.

The network-vector model may be trained using: a layer embedding vector generated by a network-vector transformation encoder on basis of the word data set for each of the plurality of neural network layers; and a reconstruction word data set for the layer embedding vector generated by a network-vector transformation decoder on basis of the layer embedding vector.

According to embodiments of the present disclosure, various configurations of neural network architectures may be embedded with numerical vectors so as to be applied to neural networks having a new structure or a customer-defined structure. Numerical analysis such as similarity analysis between neural networks is possible.

In addition, according to embodiments of the present disclosure, a continuous space optimization algorithm, such as gradient descent or Bayesian optimization, can be used by embedding a neural network architecture with numerical vectors.

Furthermore, according to embodiments of the present disclosure, due to embedding vectors generated for the neural network architecture, the neural network architecture may be used as input data in classification, generation, recommendation, transformation, and the like of the neural network.

In addition, according to embodiments of the present disclosure, by encoding categorical information including the type and parameters of a single layer of the neural network architecture, it is possible to reduce the loss of information of the layer.

### BRIEF DESCRIPTION OF THE DRAWINGS

The above and other objectives, features, and advantages of the present disclosure will be more clearly understood from the following detailed description, taken in conjunction with the accompanying drawings, in which:

FIG. 1 is a block diagram illustrating a configuration of a neural network architecture embedding device according to an embodiment;

FIG. 2 is a diagram illustrating a process of generating a word data set for a layer according to an embodiment;

FIGS. 3A and 3B are diagrams illustrating a layer-vector transformation model and a network-vector transformation model according to an embodiment;

FIG. 4 is a flowchart illustrating a neural network architecture embedding method according to an embodiment;

FIG. 5 is a diagram illustrating a configuration of a neural network architecture learning device according to an embodiment;

FIG. 6 is a diagram illustrating a learning process performed by a layer-vector learning model according to an embodiment;

FIGS. 7A and 7B are diagram illustrating a perturbation process for a reference neural network architecture according to an embodiment;

FIG. 8 is a diagram illustrating a learning process performed by a network-vector learning model according to an embodiment;

FIG. 9 is a flowchart illustrating a neural network architecture learning method according to an embodiment; and

FIG. 10 is a block diagram illustrating a computing environment including a computing device according to an embodiment.

### DETAILED DESCRIPTION

Hereinafter, specific embodiments will be described with reference to the accompanying drawings. The following detailed description is provided to assist in a comprehensive understanding of at least one of a method, a device, and a system to be described herein. However, the detailed description is merely exemplary, and the present disclosure is not limited thereto.

In the description of embodiments, a detailed description of known technologies related to the present disclosure will be omitted in the situation in which the subject matter of the present disclosure may be rendered rather unclear thereby. Terms to be used hereinafter will be defined in consideration of functions thereof in embodiments of the present disclosure, but may vary depending on the intentions of users or operators, as well as practices. Therefore, the terms shall be defined on the basis of the descriptions throughout the specification. The terms used in the detailed description shall be interpreted as being illustrative, while not being limitative, of embodiments. Unless clearly used otherwise, a singular form includes a plural meaning. It shall be understood that expressions such as “comprise,” “include,” and “have” used herein are for indicating certain features, numbers, steps, operations, elements, a part or combinations thereof and are not to be interpreted as excluding the presence or possibility of one or more features, numbers, steps, operations, elements, a part or combinations thereof other than the above.

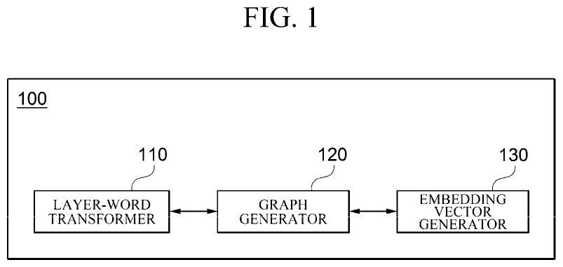

FIG. 1 is a block diagram illustrating a configuration of a neural network architecture embedding device according to an embodiment.

Referring to FIG. 1, a neural network architecture embedding device 100 according to an embodiment includes a layer-word transformer 110, a graph generator 120, and an embedding vector generator 130.

According to an embodiment, the layer-word transformer 110, the graph generator 120, and the embedding vector generator 130 may be respectively embodied using one or more physically-separated devices, one or more hardware processors, or a combination of one or more hardware processors and software, and differently from the illustrated example, specific operations thereof may not be clearly distinguished.

The neural network architecture embedding device 100 is a device configured to train a network-vector generation model to generate neural network architecture embedding vector matching an input neural network architecture. Here, the neural network architecture embedding vector may mean vectors obtained by numerically expressing a plurality of layers of the neural network architecture and the connection relationship between the layers.

The layer-word transformer 110 generates a word data set for each of a plurality of layers of the neural network architecture on the basis of one or more features of each of the plurality of layers.

The neural network architecture refers to an architecture implemented as a combination of a plurality of layers and the connection relationship between the plurality of layers and configured to overcome a specific problem.

The layer includes an operation performing a specific function, and returns an output value on the basis of the orientation function. Here, one or more parameters may be included depending on the type of the operation.

According to an embodiment, an operation of a layer means generating a new output value from one or more input values by applying a predetermined rule or a predetermined manipulation. For example, types of the operation may include Convolution, DepthwiseConvolution, BatchNormalization, ZeroPadding, MaxPooling, AvgPooling, GlobalAveragePooling, Add, Concatenate, EndOfArch, and the like.

In the meantime, the layer may include parameters to perform the operation function.

According to an embodiment, example parameters for respective operations may include {the number of filters, kernel size, strides} as parameters for Convolution operation, {kernel size, strides} as parameters for DepthwiseConv operation, {none} as a parameter for BatchNormalization operation, {padding size} as a parameter for ZeroPadding operation, {pool size, strides} as parameters for MaxPooling operation, {pool size, strides} as parameters for AvgPooling operation, {none} as a parameter for GlobalAveragePooling operation, {none} as a parameter for Add operation, {none} as a parameter for Add operation, {none} as a parameter for Concatenate operation, {none} as a parameter for Flatten operation, {none} as a parameter for EndOfArch operation, etc.

According to an embodiment, one or more features may include a type of an operation and one or more parameters of the operation.

The layer-word transformer 110 generates the word data set for each of the plurality of layers on the basis of one or more features including the type of the operation and parameters of the operation.

The term “word” refers to a unit of language that may be separated and used independently or something equivalent, and consists of one or more characters.

Specifically, the layer-word transformer 110 according to an embodiment may generate a word data set including types of operations, parameters, and length-adjusting padding by transforming the types of the operations and one or more parameters in each of the plurality of layers of the neural network architecture into words.

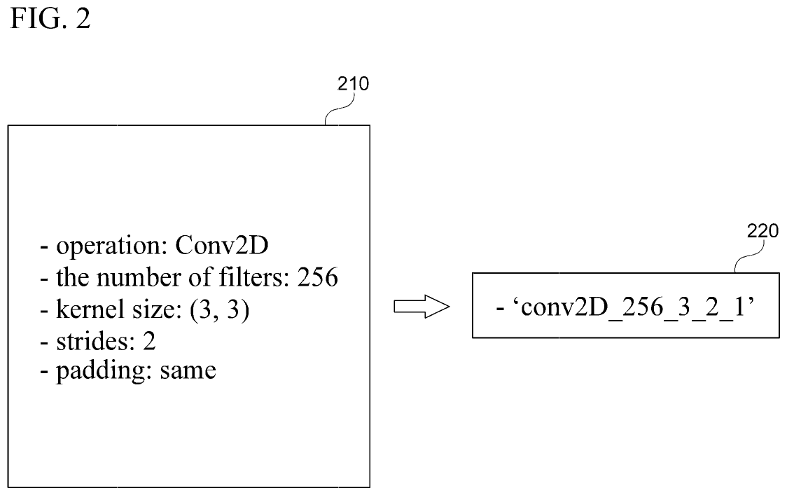

FIG. 2 is a diagram illustrating a process of generating a word data set for a layer according to an embodiment.

Specifically, FIG. 2 illustrates a process of generating a word data set for a layer including Conv2D operation.

Referring to FIG. 2, the layer-word transformer 110 may generate a word data set 220 including the types of the operations, parameters, and length-adjusting padding by transforming the types of the operations and one or more parameters in the layer into words, on the basis of a feature 210 of the layer.

Specifically, the layer feature 210 may include information regarding an operation type {Conv2D}, parameters {the number of filters: 256, kernel size: (3,3), strides: 2}, and padding {padding: same}.

The layer may be transformed into the word data set 220 “conv2D_256_3_2_1” on the basis of the layer feature 210 by the layer-word transformer 110.

The graph generator 120 generates a graph regarding the neural network architecture on the basis of the word data set and the connection relationship between the plurality of layers.

According to an embodiment, the graph may include a node corresponding to the word data set for each of the plurality of layers and a mainline corresponding to the connection relationship between the plurality of layers. For example, the graph may be a directed acyclic graph (DAG), but is not limited thereto.

The embedding vector generator 130 generates a neural network architecture embedding vector for the neural network architecture by inputting the graph regarding the neural network architecture to a pre-trained network-vector transformation model.

According to an embodiment, the embedding vector generator 130 may generate a layer embedding vector by inputting the word data set corresponding to a node of a graph to a pre-trained layer-vector transformation model. Afterwards, a position embedding vector for the connection relationship between the plurality of layers may be generated by inputting the connection relationship between the plurality of layers corresponding to the mainline of the graph to a relative position encoder. Thereafter, a neural network architecture embedding vector for the neural network architecture may be generated by inputting the layer embedding vector and the position embedding vector to the pre-trained network-vector transformation model.

In the following embodiments, the “layer-vector transformation model” means a model including a deep neural network for generating a layer embedding vector by transforming a layer into a vector on the basis of the word data set generated by transforming one or more features of the layer into text (or letters).

According to an embodiment, the layer-vector transformation model may include a character convolutional neural network (hereinafter, referred to as a “character CNN”) configured to learn the correlation between words of the word data set from combinations of characters constituting each word.

In addition, in the following embodiments, the “network-vector transformation model” means a model including a deep neural network for generating a neural network architecture embedding vector by transforming a neural network architecture into a vector on the basis of a graph regarding the neural network architecture.

According to an embodiment, the network-vector transformation model may include a relative position encoder for transforming the dimension of the connection relationship between the plurality of layers.

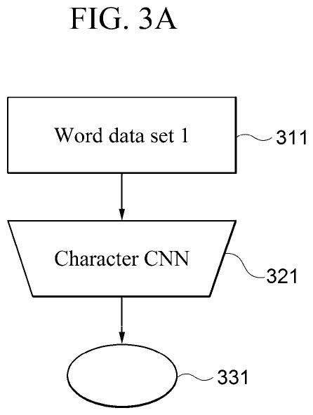

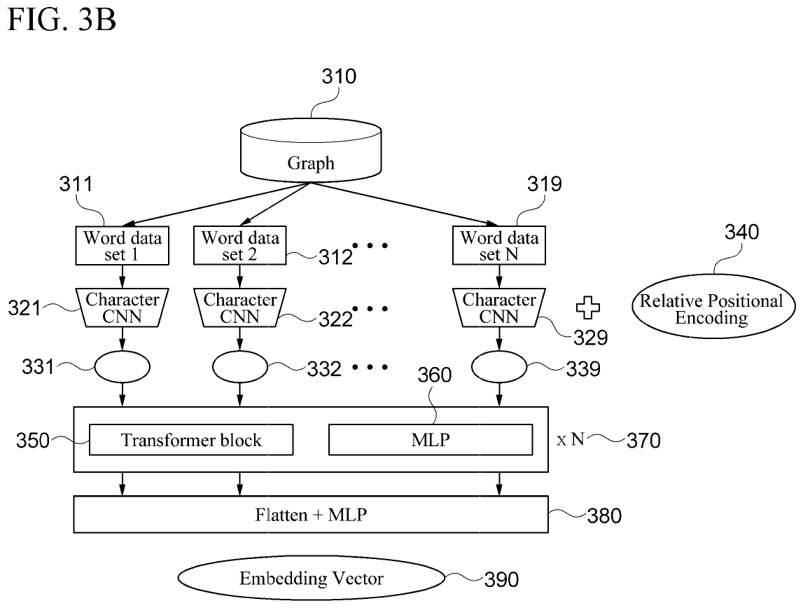

FIGS. 3A and 3B are diagrams illustrating a layer-vector transformation model and a network-vector transformation model according to an embodiment.

Specifically, FIG. 3A is a diagram illustrating the layer-vector transformation model according to an embodiment. Here, the layer-vector transformation model may include a character CNN architecture 312 learning the correlation between words of the word data set from a combination of characters constituting each words.

Referring to FIG. 3A, the embedding vector generator 130 may generate a layer embedding vector for each of a plurality of layers by inputting a word data set for each of a plurality of layers of a neural network architecture of a graph regarding the neural network architecture to a pre-trained layer-vector transformation model.

Specifically, according to an embodiment, the embedding vector generator 130 may generate a layer embedding vector 331 for a word data set 1 by inputting the word data set 1 to a character pre-trained layer-vector transformation model 321.

FIG. 3B is a diagram illustrating a network-vector transformation model according to an embodiment.

Referring to FIG. 3B, the embedding vector generator 130 may generate layer embedding vectors 331, 332, . . . , and 339 for a plurality of layers by inputting first to Nth word data sets 311, 312, . . . , and 319 for the plurality of layers of a neural network architecture of a graph 310 regarding the neural network architecture.

According to an embodiment, the embedding vector generator 130 may generate position embedding vectors for the connection relationship between the plurality of layers by inputting the connection relationship between the plurality of layers of the neural network architecture of the graph regarding the neural network architecture to a relative position encoder 340.

Afterwards, the embedding vector generator 130 may generate a neural network architecture embedding vector 390 by inputting the layer embedding vectors 331, 332, . . . , and 339 and the position embedding vectors to the pre-trained network-vector transformation model.

Specifically, according to an embodiment, the embedding vector generator 130 may input the layer embedding vectors 331, 332, . . . , and 339 and the position embedding vectors to a transformer block 350 so that contextual features between nodes of the neural network architecture are learned. Here, for example, the transformer block 350 may be trained by the number 370 of nodes in the graph corresponding to the neural network architecture.

Afterwards, an embedding vector 390 for the neural network architecture may be generated by allowing the layer embedding vectors 331, 332, . . . , and 339 and the position embedding vectors to pass through a multilayer perceptron (MLP) 360 in charge of normalization and then merging the layer embedding vectors 331, 332, . . . , and 339 and the position embedding vectors by means of a Flatten MLP 380.

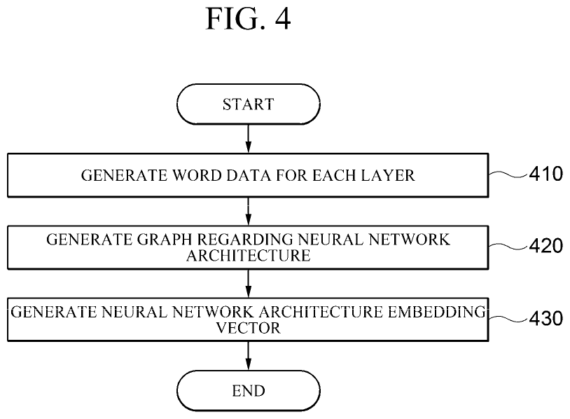

FIG. 4 is a flowchart illustrating a neural network architecture embedding method according to an embodiment.

The method illustrated in FIG. 4 may be performed, for example, by the neural network architecture embedding device 100 illustrated in FIG. 1.

Referring to FIG. 4, in 410, the neural network architecture embedding device 100 generates a word data set for each of a plurality of layers on the basis of one or more features of each of the plurality of layers of a neural network architecture.

Afterwards, in 420, the neural network architecture embedding device 100 generates a graph regarding the neural network architecture on the basis of the word data set and the connection relationship between the plurality of layers.

Subsequently, in 430, the neural network architecture embedding device 100 generates a neural network architecture embedding vector for the neural network architecture by inputting the graph regarding the neural network architecture to a pre-trained network-vector transformation model.

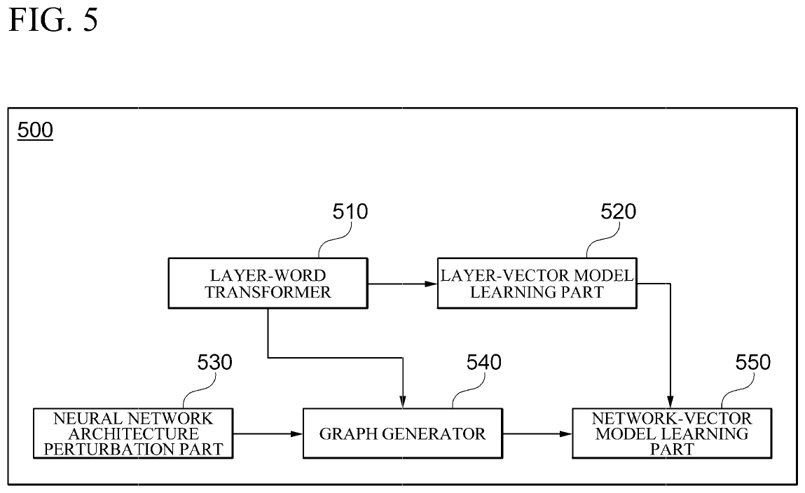

FIG. 5 is a diagram illustrating a configuration of a neural network architecture learning device according to an embodiment.

Referring to FIG. 5, a neural network architecture learning device (hereinafter, referred to as a “learning device”) 500 according to an embodiment includes a layer-word transformer 510, layer-vector model learning part 520, a neural network architecture perturbation part 530, a graph generator 540, and a network-vector model learning part 550.

According to an embodiment, the layer-word transformer 510, the layer-vector model learning part 520, the neural network architecture perturbation part 530, the graph generator 540, and the network-vector model learning part 550 may be respectively embodied using one or more physically-separated devices, one or more hardware processors, or a combination of one or more hardware processors and software, and differently from the illustrated example, specific operations thereof may not be clearly distinguished.

The neural network architecture learning device 500 is a device configured to train the network-vector generation model to generate perturbed neural network architecture embedding vectors capable of embedding a plurality of perturbed neural network architectures in which a reference neural network architecture is perturbed variously on the basis of an input reference neural network architecture. Here, the perturbed neural network architecture embedding vectors may mean vectors numerically expressing layers of a plurality of perturbed neural network architectures and the connection relationship between the plurality of layers.

The layer-word transformer 510 generates a word data set for each of the plurality of layers on the basis of one or more features of each of the plurality of layers.

The layer-vector model learning part 520 may be pre-trained by the neural network architecture learning device 500 to generate a layer embedding vector corresponding to each of the plurality of neural network layers using the word data set for each of the plurality of neural network layers.

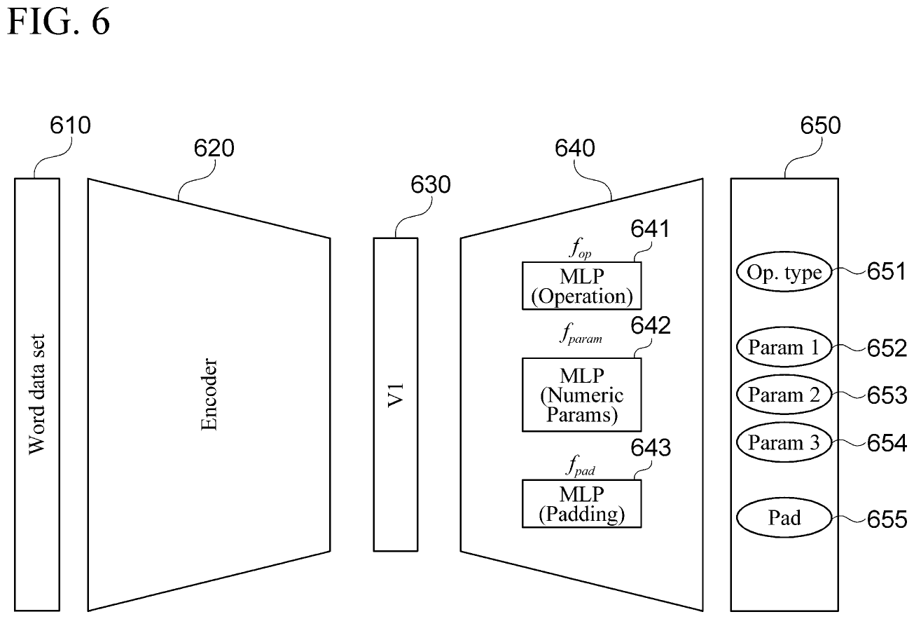

FIG. 6 is a diagram illustrating a learning process performed by a layer-vector learning model according to an embodiment.

Specifically, according to an embodiment, the layer-vector learning model may include a layer-vector transformation encoder 620 and a layer-vector transformation decoder 640.

Referring to FIG. 6, according to an embodiment, the neural network architecture learning device 500 may allow the layer-vector learning model to be pre-trained using a reconstruction word data set for the layer embedding vector generated by the layer-vector transformation decoder 640 on the basis of a layer embedding vector v1 630 generated by the layer-vector transformation encoder 620 and the layer embedding vector, on the basis of a word data set 610 for each of the plurality of neural network layers.

Specifically, the neural network architecture learning device 500 may allow the layer-vector transformation encoder 620 and the layer-vector transformation decoder 640 to be pre-trained so as to minimize reconstruction loss of the word data set 610 and a reconstruction word data set 650, using the word data set as an input.

As illustrated in FIG. 6, the layer-vector transformation decoder 640 may include an operation decoder 641, a parameter decoder 642, and a padding decoder 645 for decoding types of operations, parameters, and padding, respectively. Here, the operation decoder 641, the parameter decoder 642, and the padding decoder 645 may allow the layer-vector learning model to be trained to generate a reconstruction operation 651, first to third reconstruction parameters 652, 653, and 654, and reconstruction padding 655 for the types of the operations, the parameters, and the padding, respectively, on the basis of the layer embedding vector v1 630.

Specifically, the layer-vector learning model may be trained according to reconstruction loss represented by the following Equation 1.

$${loss}_{reconst} = \frac{1}{\vert ( B ) \vert} {\sum }_{l ϵ ( B )} ( - {l}_{op} \cdot log ( {f}_{op} ( g ( l ) ) ) + {\sum }_{k = 1}^{3} {( {l}_{{param}_{k}} - {f}_{param} ( g ( l ) ) [ k ] )}^{2} + ( - {l}_{pad} \cdot log ( {f}_{pad} ( g ( l ) ) ) ) ) , \qquad ( 1 )$$

where g(l) indicates the layer-vector transformation encoder 620, fₒₚ(g(l)) indicates a transformation decoder for operation, fₚₐᵣₐₘ(g(l)) indicates a transformation decoder for parameters, f_{pad}(g(l)) indicates a transformation decoder for padding, lₒₚ indicates loss for operation, l_{param_1}, l_{param_2}, and l_{param_3} indicate losses for parameters, respectively, and l_{pad} indicates loss for padding.

The neural network architecture perturbation part 530 may perform one or more perturbations processes to generate a plurality of perturbed neural network architecture regarding a reference neural network architecture.

The perturbation corresponds to a pre-processing process for amplifying learning data for embedding by learning a variety of neural network architectures by means of the neural network architecture learning device 500.

According to an embodiment, one or more perturbations may include at least one of mutation for at least one layer of the plurality of neural network layers and crossover of two or more of the plurality of layers.

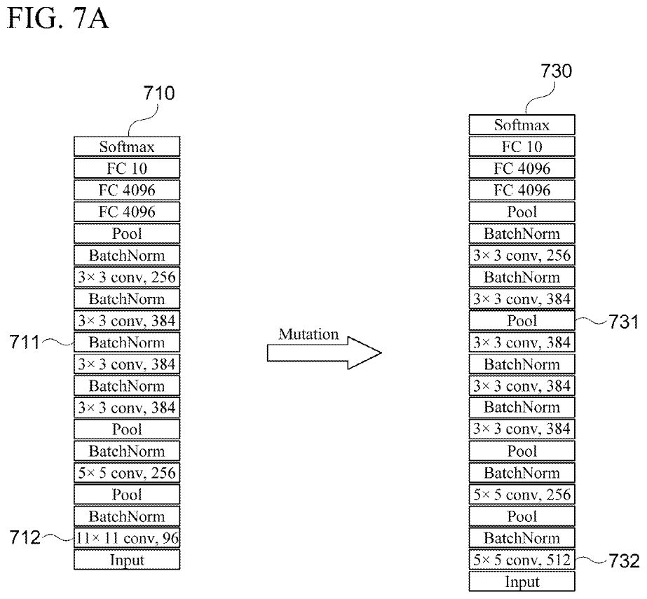

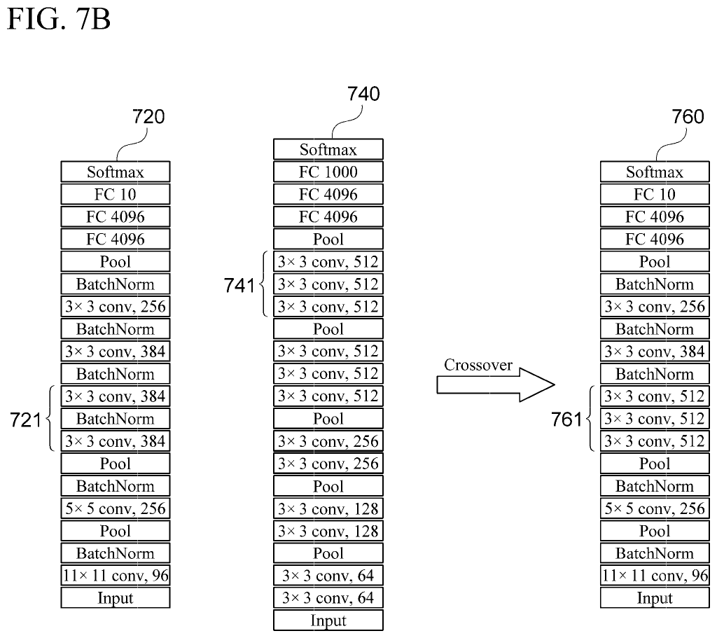

FIGS. 7A and 7B are diagram illustrating a perturbation process for a reference neural network architecture according to an embodiment.

Specifically, FIG. 7A is a diagram illustrating a process of performing mutation to at least one layer of the reference neural network architecture.

Referring to FIG. 7A, the neural network architecture perturbation part 530 may generate a perturbed AlexNet neural network architecture 730 obtained by perturbing at least one feature of a layer on the basis of an AlexNet neural network architecture 710.

For example, the neural network architecture perturbation part 530 may generate the perturbed AlexNet neural network architecture 730 by replacing 11×11 conv, 96 712 and BatchNorm 711 in the AlexNet neural network architecture 710 with 11×11 conv, 96 732 and Pool 731.

Specifically, FIG. 7B is a diagram illustrating a process of crossovering portions of the reference neural network architecture.

Referring to FIG. 7B, the neural network architecture perturbation part 530 may generate a perturbed AlexNet neural network architecture 760 by crossovering portions of first and second AlexNet neural network architectures 720 and 740.

For example, the neural network architecture perturbation part 530 may generate the perturbed AlexNet neural network architecture 760 by crossovering a portion 721 of the first AlexNet neural network architecture 720 with a portion 741 of the second AlexNet neural network architecture 740.

The graph generator 540 generates a word data set for each of a plurality of layers of a plurality of perturbed neural network architectures on the basis of one or more features of each of the plurality of layers, and generates a graph for each of the plurality of perturbed neural network architectures on the basis of the word data set and the connection relationship between the plurality of layers.

The network-vector model learning part 550 may train with the network-vector learning model to generate neural network architecture embedding vectors corresponding to the plurality of neural network architectures, respectively, using word data sets for the plurality of layers of the plurality of neural network architectures and the connection relationship between the plurality of layers.

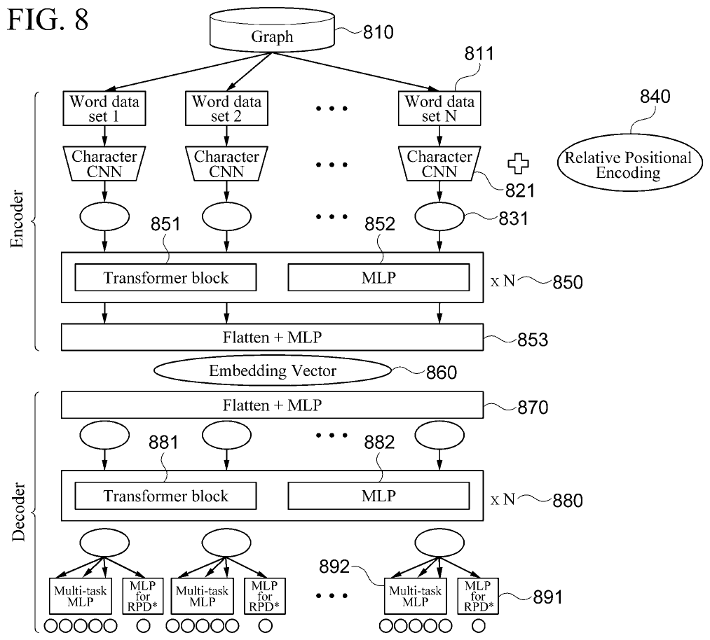

FIG. 8 is a diagram illustrating a learning process performed by a network-vector learning model according to an embodiment.

Specifically, according to an embodiment, the network-vector learning model may include a network-vector encoder and a network-vector decoder.

According to an embodiment, the neural network architecture learning device 500 may train the encoder and the decoder of the network-vector model on the basis of a graph 810 for a perturbed neural network architecture.

Referring to FIG. 8, the neural network architecture learning device 500 may train the encoder of the network-vector model to generate a layer embedding vector 831 for each of a plurality of perturbed layers corresponding to nodes of a graph 810 regarding a plurality of perturbed neural network architectures by inputting first to Nth word data sets 821 for the plurality of perturbed layers to a pre-trained layer-vector model 811.

According to an embodiment, the encoder of the network-vector model may be trained to generate a position embedding vector for the connection relationship between the plurality of perturbed layers by inputting the connection relationship between the plurality of perturbed layers corresponding to the graph 810 regarding the perturbed neural network architecture to a relative position encoder 840.

Afterwards, the neural network architecture learning device 500 may train the encoder of the network-vector model to generate a perturbed neural network architecture embedding vector 860 for the perturbed neural network architecture by inputting the layer embedding vector 831 and the position embedding vector to the encoder of the pre-trained network-vector transformation model.

Specifically, according to an embodiment, the neural network architecture learning device 500 may allow the contextual feature between nodes of the neural network architecture to be learned by inputting the layer embedding vector 831 and the position embedding vector to the transformer block 851. Here, for example, the transformer block 851 may be trained by the number 850 of nodes of the graph regarding the perturbed neural network architecture.

Afterwards, the neural network architecture learning device 500 may train the encoder of the network-vector model to generate the perturbed neural network architecture embedding vector 860 by allowing the layer embedding vectors and the position embedding vectors to pass through an MLP 852 in charge of normalization and then merging the layer embedding vectors and the position embedding vectors by means of a Flatten MLP 853.

To decode the perturbed neural network architecture embedding vector 860, the neural network architecture learning device 500 may split the perturbed neural network architecture embedding vector 860 by the unit corresponding to a node by means of a split MLP 870.

According to an embodiment, the neural network architecture learning device 500 may allow the contextual feature between nodes to be learned in order to restore the perturbed neural network architecture by means of a transformer block 881 on the basis of the perturbed neural network architecture embedding vector 860 split by the unit corresponding to a node. Here, for example, the transformer block 881 may be trained by the number 880 of nodes included in the graph regarding the perturbed neural network architecture.

According to an embodiment, the neural network architecture learning device 500 may perform the training using a reconstruction word data set regarding the layer embedding vector and the position embedding vector generated by the decoders 892 and 891 of the network-vector transformation model.

Specifically, the network-vector learning model may be learned according to reconstruction loss of the following Equation 2:

$${loss}_{reconst} = \frac{1}{\vert ( B ) \vert} {\sum }_{l ϵ ( B )} ( - {l}_{op} \cdot log ( {f}_{op} ( g ( l ) ) ) + {\sum }_{k = 1}^{3} {( {l}_{{param}_{k}} - {f}_{param} ( g ( l ) ) [ k ] )}^{2} + ( - {l}_{pad} \cdot log ( {f}_{pad} ( g ( l ) ) ) ) ) , \qquad ( 2 )$$

where g(l) indicates a network-vector transformation encoder, fₒₚ(g(l)) indicates a decoder for operation, fₚₐᵣₐₘ(g(l)) indicates a decoder for parameters, a f_{pad}(g(l)) indicates a transformation decoder for padding, lₒₚ indicates loss for operation, l_{param_1}, l_{param_2}, and l_{param_3} indicate losses for parameters, respectively, and l_{pad} indicates loss for padding.

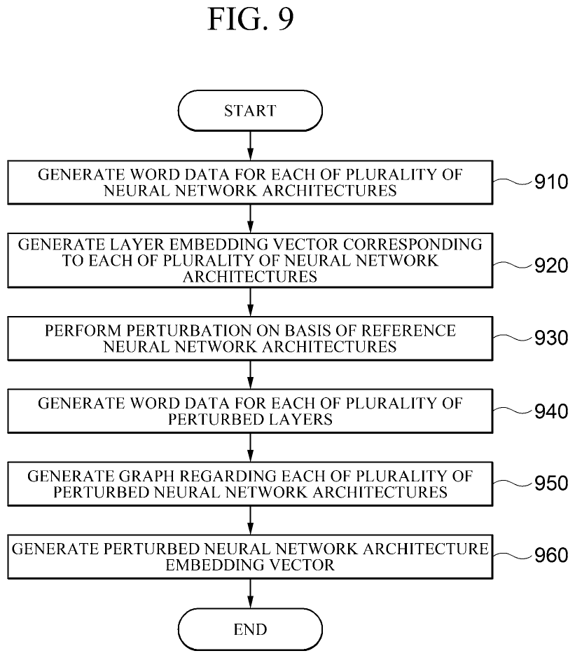

FIG. 9 is a flowchart illustrating a neural network architecture learning method according to an embodiment.

The method illustrated in FIG. 9 may be performed, for example, by the neural network architecture learning device 500 illustrated in FIG. 1.

Referring to FIG. 9, in 910, the neural network architecture learning device 500 generates a word data set for each of a plurality of neural network layers on the basis of one or more features of each of the plurality of neural network layers.

Afterwards, in 920, the neural network architecture learning device 500 train the layer-vector learning model to generate a layer embedding vector corresponding to each of the plurality of neural network layers using the word data set for each of the plurality of neural network layers.

Thereafter, in 930, the neural network architecture learning device 500 performs one or more perturbation processes to generate a plurality of perturbed neural network architectures regarding a reference neural network architecture.

Subsequently, in 940, the neural network architecture learning device 500 generates a word data set for each of a plurality of layers of the plurality of perturbed neural network architecture on the basis of one or more features of each of the plurality of layers.

Afterwards, in 950, the neural network architecture learning device 500 generates a graph regarding each of the plurality of perturbed neural network architectures on the basis of the word data set and the connection relationship between the plurality of layers.

Subsequently, in 960, the neural network architecture learning device 500 trains the network-vector learning model to generate a neural network architecture embedding vector corresponding to each of the plurality of neural network architectures using the word data set for each of the plurality of layers of the plurality of neural network architecture and the connection relationship between the plurality of layers.

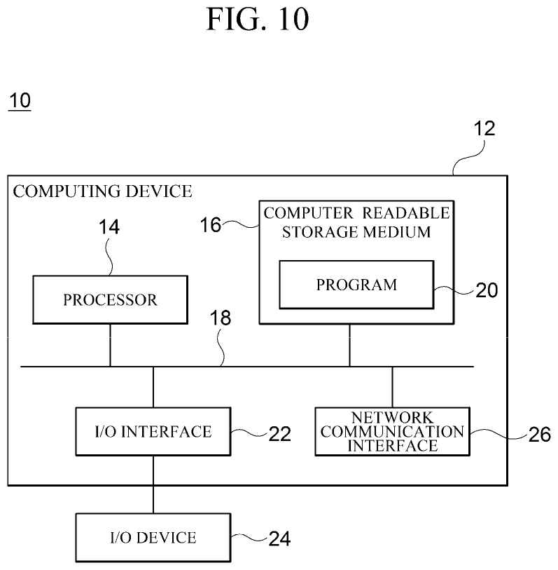

FIG. 10 is a block diagram illustrating a computing environment 10 including a computing device according to an embodiment. In the illustrated embodiment, each component may have a function and capability different from those to be described below, and additional components not described below may be included.

The illustrated computing environment 10 includes a computing device 12. According to an embodiment, the computing device 12 may be the neural network architecture embedding device 100 illustrated in FIG. 1 or neural network architecture learning illustrated in FIG. 4.

The computing device 12 includes at least one processor 14, a computer readable storage medium 16, and a communication bus 18. The processor 14 may allow the computing device 12 to operate according to the example embodiments described above. For example, the processor 14 may execute one or more programs stored in the computer readable storage medium 16. The one or more programs may include one or more computer executable instructions. The computer executable instructions may be configured to allow the computing device 12 to perform the operations according to the example embodiments when executed by the processor 14.

The computer readable storage medium 16 may be configured to store computer executable instructions, program codes, program data, and/or other suitable forms of information. A program 20 stored in the computer readable storage medium 16 may include a set of instructions executable by the processor 14. According to an embodiment, the computer readable storage medium 16 may be a memory (e.g., a volatile memory such as a random access memory (RAM), a non-volatile memory, or a combination thereof), one or more magnetic disk storage devices, optical disk storage devices, flash memory devices, other types of storage media which can be accessed by the computing device 12 and store intended information, or combinations thereof.

The communication bus 18 may include the processor 14 and the computer readable storage medium 16, and interconnect various components of the computing device 12 to each other.

The computing device 12 may include one or more input/output (I/O) interfaces 22 providing an interface for one or more I/O devices 24 and one or more network communication interfaces 26. The I/O interface 22 and the network communication interfaces 26 may be connected to the communication bus 18. The I/O devices 24 may include input devices, such as a pointing device (e.g., a mouse and a track pad), a keyboard, a touch input device (e.g., a touch pad and a touch screen), a voice or sound input device, various types of sensors, and/or a capturing device, and/or output devices, such as a display device, a printer, a speaker, and/or a network card. Each of the I/O devices 24 may be one component constituting the computing device 12, may be included in the computing device 12, or may be connected to the computing device 12 as a device separate from the computing device 12.

In addition, exemplary embodiments of the present disclosure may include a computer readable storage medium including a program for performing the methods described in this specification in a computer. The computer readable storage medium may separately include program commands, local data files, local data structures, or include a combination thereof. The medium may be specially designed and configured for the present disclosure, or known to those having ordinary knowledge in the field of computer software and available. Examples of the computer readable storage medium include: magnetic media, such as a hard disk, a floppy disk, and a magnetic tape; optical recording media, such as a compact disc read-only memory (CD-ROM) and a digital versatile disc (DVD); and hardware devices, such as a read-only memory (ROM), a random access memory (RAM), and a flash memory, specially configured to store and perform program commands. Examples of the program commands may include high-level language codes executable by a computer using an interpreter, etc., as well as machine language codes made by compilers.

Although the exemplary embodiments of the present disclosure have been described in detail hereinabove, those having ordinary knowledge in the technical field to which the present disclosure pertains will appreciate that various modifications are possible to the foregoing embodiments without departing from the scope of the present disclosure. Therefore, the scope of protection of the present disclosure shall not be limited to the foregoing embodiments but shall be defined by the appended Claims and equivalents thereof

What is claimed is:

1. A neural network architecture embedding method performed by a computing device comprising one or more processors and a memory storing one or more programs executed by the one or more processors, the method comprising:
generating a word data set for each of a plurality of layers of a neural network architecture on basis of one or more features of each of the plurality of layers;
generating a graph regarding the neural network architecture on basis of the word data set and connection relationship between the plurality of layers; and
generating a neural network architecture embedding vector for the neural network architecture by inputting the graph to a pre-trained network-vector transformation model.

2. The neural network architecture embedding method of claim 1, wherein the one or more features comprise a type of an operation and one or more parameters of the operation.

3. The neural network architecture embedding method of claim 1, wherein the graph comprises a node corresponding to the word data set for each of the plurality of layers and a mainline corresponding to the connection relationship between the plurality of layers.

4. The neural network architecture embedding method of claim 1, wherein the generating of the neural network architecture embedding vector comprises:
generating a layer embedding vector by inputting the graph to a pre-trained layer-vector transformation model;
generating a position embedding vector for the connection relationship between the plurality of layers by inputting the graph to a relative position encoder; and
generating the neural network architecture embedding vector for the neural network architecture by inputting the layer embedding vector and the position embedding vector to the pre-trained network-vector transformation model.

5. The neural network architecture embedding method of claim 4, wherein the layer-vector transformation model comprises a character convolutional neural network architecture configured to learn correlation between words of the word data set from combinations of characters constituting each word.

6. The neural network architecture embedding method of claim 5, wherein the network-vector transformation model comprises a relative position encoder configured to transform a dimension of the connection relationship between the character convolutional neural network and the plurality of layers.

7. A neural network architecture embedding device comprising:
a layer-word transformer configured to generate a word data set for each of a plurality of layers of a neural network architecture on basis of one or more features of each of the plurality of layers;
a graph generator configured to generate a graph regarding the neural network architecture on basis of the word data set and connection relationship between the plurality of layers; and
an embedding vector generator configured to generate a neural network architecture embedding vector for the neural network architecture by inputting the graph regarding the neural network architecture to a pre-trained network-vector transformation model.

8. The neural network architecture embedding device of claim 7, wherein the one or more features comprise a type of an operation and one or more parameters of the operation.

9. The neural network architecture embedding device of claim 7, wherein the graph comprises a node corresponding to the word data set for each of the plurality of layers and a mainline corresponding to the connection relationship between the plurality of layers.

10. The neural network architecture embedding device of claim 7, wherein the embedding vector generator:
generates a layer embedding vector by inputting the graph to a pre-trained layer-vector transformation model;
generates a position embedding vector for the connection relationship between the plurality of layers by inputting the graph to a relative position encoder; and
generates the neural network architecture embedding vector for the neural network architecture by inputting the layer embedding vector and the position embedding vector to the pre-trained network-vector transformation model.

11. The neural network architecture embedding device of claim 7, wherein the layer-vector transformation model comprises a character convolutional neural network architecture configured to learn correlation between words of the word data set from combinations of characters constituting each word.

12. The neural network architecture embedding device of claim 11, wherein the network-vector transformation model comprises a relative position encoder configured to transform a dimension of the connection relationship between the character convolutional neural network and the plurality of layers.

13. A neural network architecture embedding device comprising:
a layer-word transformer generating a word data set for each of a plurality of neural network layers on basis of one or more features of each of the plurality of neural network layers;
a layer-vector model learning part training a layer-vector learning model to generate a layer embedding vector corresponding to each of the plurality of neural network layers, using the word data set for each of the plurality of neural network layers;
a neural network architecture perturbation part performing one or more perturbations to generate a plurality of perturbed neural network architectures for a reference neural network architecture;
a graph generator generating a word data set for each of a plurality of perturbed layers of the plurality of perturbed neural network architectures on basis of one or more features of each of the plurality of perturbed layers and generating a graph regarding each of the plurality of perturbed neural network architectures on basis of the word data set and connection relationship between the plurality of layers; and
a network-vector model learning part training a network-vector learning model to generate a perturbed neural network architecture embedding vector corresponding to each of the plurality of perturbed neural network architectures, using the word data set for each of the plurality of perturbed layers of the plurality of perturbed neural network architectures and connection relationship between the plurality of perturbed layers.

14. The neural network architecture embedding device of claim 13, wherein the one or more perturbations comprise at least one of mutation for at least one layer of the plurality of neural network layers and crossover of two or more of the plurality of layers.

15. The neural network architecture embedding device of claim 13, wherein the layer-vector learning model is trained using:
a layer embedding vector generated by a layer-vector transformation encoder on basis of the word data set for each of the plurality of perturbed neural network layers; and
a reconstruction word data set for the layer embedding vector generated by a layer-vector transformation decoder on basis of the layer embedding vector.

16. The neural network architecture embedding device of claim 13, wherein the network-vector model is trained using:
a layer embedding vector generated by a network-vector transformation encoder on basis of the word data set for each of the plurality of neural network layers; and
a reconstruction word data set for the layer embedding vector generated by a network-vector transformation decoder on basis of the layer embedding vector.
